(19) United States
(12) Patent Application Publication
(10) Pub. No.: US 2026/0285135 A1
(43) Pub. Date: Sep. 24, 2026

(54) VEHICLE GLAZING ASSEMBLY, VEHICLE ROOF, MOLD AND ASSOCIATED METHODS AND USE

(71) Applicant: AGC GLASS EUROPE, Louvain-la-Neuve (BE)

(72) Inventors: Jaroslav STEPAN, Gosselies (BE); Miroslav HOLEK, Gosselies (BE); Roman HYNEK, Gosselies (BE)

(73) Assignee: AGC GLASS EUROPE, Louvain-la-Neuve (BE)

(21) Appl. No.: 19/476,025

(22) PCT Filed: Jun. 5, 2024
(86) PCT No.: PCT/EP2024/065372

§ 371 Date: Oct. 16, 2025

(30) Foreign Application Priority Data
Jun. 5, 2023 (EP) 23177192.4

(51) Int. Cl. B60J 7/16; B60J 1/00; B60J 10/15; B60J 10/70

(52) U.S. Cl. CPC B60J 7/16; B60J 1/001; B60J 10/15; B60J 10/70

(57) ABSTRACT

A vehicle glazing assembly designed to be fixed to a vehicle body includes a glazing panel having an exterior surface facing the exterior of the unit on which the glazing will be assembled, the panel having at least one notch. The vehicle glazing assembly further includes a fixing box located in the notch and a primary part framing the fixing box and connecting the fixing box to the glazing panel; the primary part being in the form of a sealing component. The fixing box allows access to the vehicle body through the fixing box and at least a portion of the primary part is disposed in a flush manner with the exterior surface. Also included is a vehicle roof including a glazing assembly, a vehicle including a vehicle roof, a method to manufacture a glazing assembly and a mold to produce a glazing assembly.

### TECHNICAL FIELD

The present invention relates to a vehicle glazing assembly designed to be fixed to a vehicle body, in general and, more specifically, to an enhanced vehicle glazing assembly comprising a fixing box allowing access to the vehicle body through the fixing box.

Said vehicle glazing assembly is designed to fixed to a vehicle body such as a motor/electric/hybrid vehicle, a car, a bus, a truck, a train, a boat, or alike as a part of a vehicle roof for example.

### Background Art

Today, vehicle manufacturers are using more and more glazing assemblies to enhance the vision from the inside to the environment especially on a roof or a cielo windshield, windshield extending into the vehicle roof and then part of the vehicle roof.

On the other hands, vehicle roofs is an ideal location to install external elements such as beacons, headlights, racks, bike racks, roof boxes, skis or alike.

Various methods have been proposed for fixing such external elements to a vehicle. Usually, vehicle roofs are fixed to the vehicle body and said external elements are fixed to the vehicle body directly next to the location of a glazing assembly.

These solutions permits to easily install an external element to a roof without risk of touching the glazing assembly.

However, this solution can lead to vibrations between the fixed external element and the glazing assembly next to it.

On top of that, such solutions leads to a reduced surface for the vision to the environment.

Another solution is to install lateral racks at the border of the roof and fix an external element on said lateral racks.

Said solution leads to an increase of the needed dimensions, especially the height, to fix said external elements. In case of external element such as roof racks, bike racks or alike, transversal racks are needed between said external element and the lateral racks. The height is the sum of height all needed lateral racks, longitudinal racks and the external element.

This solution reduces the vehicle's air penetration coefficient and increases fuel/electricity consumption while increasing the vehicle's wind resistance.

On top of that, existing solutions needs many elements to assemble said system to a vehicle, increasing the cost.

### SUMMARY OF INVENTION

Thus, to solve these problems, the present invention proposes an enhanced vehicle glazing unit.

The present invention relates, in a first aspect, to a vehicle glazing assembly designed to be fixed to a vehicle body and comprising a glazing panel, having an exterior surface facing the exterior of the unit on which the glazing will be assembled. The gazing panel comprises at least a notch.

The solution as defined in the first aspect of the present invention is based on that the vehicle glazing assembly further comprises a fixing box located in one of the at least a notch and a primary part framing the fixing box and connecting the fixing box to the glazing panel; the primary part which is in the form of a sealing component

The solution as defined in the first aspect of the present invention is also based on that the fixing box allows access to the vehicle body through the fixing box.

The solution as defined in the first aspect of the present invention is also based on that at least a portion of the primary part is disposed in a flush manner with the exterior surface.

The present invention relates, in a second aspect, to a vehicle roof comprising a vehicle glazing assembly according to the first aspect of the present invention.

The present invention relates, in a third aspect, to a vehicle comprising a vehicle body and a vehicle roof according to the second aspect, wherein the vehicle body comprises at least one fixation means; each of the at least one fixation means is designed to fix an external element, wherein each of the fixing boxes, corresponds respectively to one of the at least one fixation means.

The present invention relates, in a fourth aspect, to a method to manufacture a vehicle glazing assembly according to the first aspect, wherein the method comprises following steps:

| | |
|---|---|
| Step A. | Providing (81) the glazing panel |
| Step B. | Injecting (82) the sealing component |
| Step C. | Providing (83) the at least one fixing box |
| Step D. | Placing (84) each of the at least one fixing box in a space |
| | created in the primary part. |

The present invention relates, in a fifth aspect, to a method to mount an external element to a vehicle according to the third aspect.

The present invention relates, in a sixth aspect, to a mould to produce a vehicle glazing assembly according to the first aspect of the present invention,

the mould being designed to receive at least a part of the glazing unit on which the primary part will be inserted, characterized in that the mould comprises a cavity to create by injection the primary part.

The present invention relates, in a seventh aspect, to an use to clip an external element to a body of a vehicle through a fixing box of a vehicle gazing assembly according to the first aspect.

Thus, the invention, through the different aspects of which it is composed, make it possible to solve the need to easily fix an external element to a vehicle body while reducing the vehicle's air penetration coefficient.

On top of that, thanks to the invention, through the different aspects of which it is composed, the surface of the glazing can be increased, the vision from the inside to the environment is increased. That permits a significant increase in the surface of glazing that a roof can accommodate. This brings the great advantage of having a much larger surface accessible via the roof than in the current vehicles allowing operators and or machines wider access to the interior of the vehicle. For example, the installation of seats and benches could be done through the roof rather than laterally. This allows for easier handling.

The invention, through the different aspects of which it is composed, also permits to reduce vibrations between external element and the vehicle glazing assembly.

It is noted that the invention relates to all possible combinations of features recited in the claims or in the described embodiments.

The following description relates to automotive but it's understood that the invention may be applicable to others fields like transportation applications in general or alike.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of a vehicle glazing assembly of a first embodiment according to the first aspect of the invention

FIG. 2 is a schematic view of a vehicle glazing assembly of a second embodiment according to the first aspect of the invention.

FIG. 3 is a schematic view of a glazing unit of a third embodiment.

FIG. 4 is schematic view of a the glazing panel of FIG. 3 with a primary part and boxes to be assembled.

FIG. 5 is schematic view of a vehicle glazing assembly according to the first aspect of the invention with the glazing panel of FIG. 3 and FIG. 4

FIG. 6 is a schematic sectional view of FIG. 5 along plane BB′.

FIG. 7 is a schematic 3D view of a notch according to the first aspect of the invention in the zoom ZA.

FIG. 8 is a schematic sectional view of FIG. 5 along plane AA′.

FIG. 9 is a schematic 3D view of a top element of a fixing box according to the invention.

FIG. 10 is a schematic 3D view of a bottom element of a fixing box according to the invention.

FIG. 11 is a schematic 3D view of a fixing box assembled from the top element of FIG. 10 and the bottom element of FIG. 9 according to the invention.

FIG. 12 is a schematic sectional view of a pre-assembled vehicle glazing assembly where the fixing box comprises a top element and a bottom element.

FIG. 13 is a schematic view of a method according to the fourth aspect of the present invention.

### DETAILED DESCRIPTION

In this document to a specific embodiment and include various changes, equivalents, and/or replacements of a corresponding embodiment. The same reference numbers are used throughout the drawings to refer to the same or like parts. Other variations can be envisaged within the scope of the claims.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated. herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems.

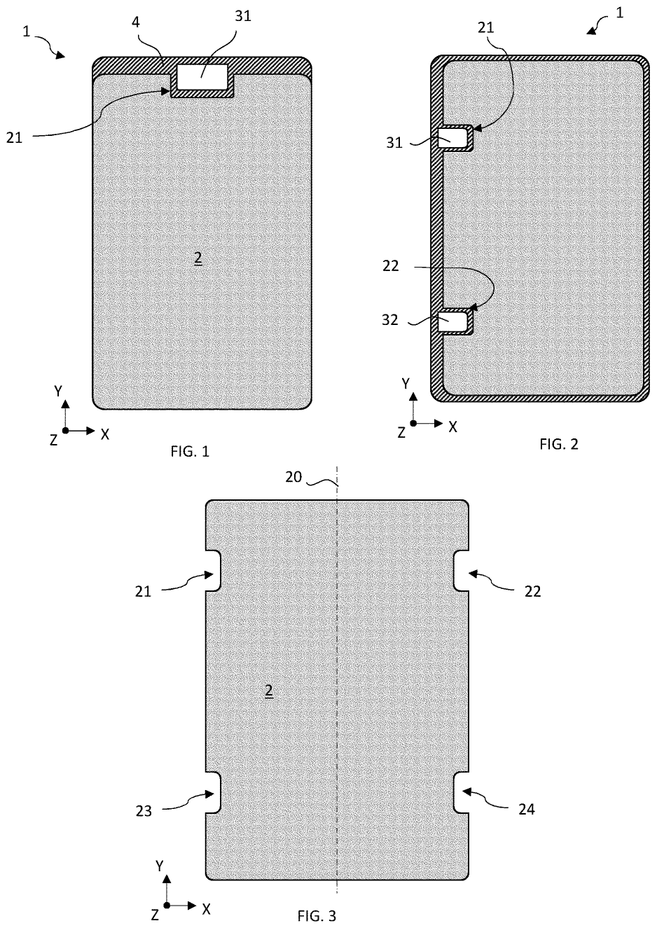

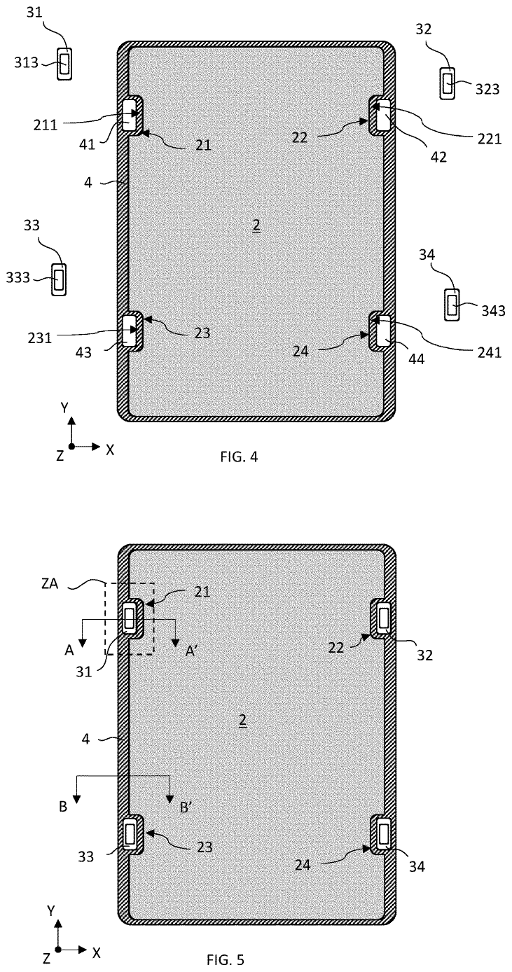

According to a first aspect of the invention, as illustrated in FIG. 1, FIG. 2, FIG. 4 and FIG. 5, the invention relates to a vehicle glazing assembly 1 comprising a glazing panel 2 comprising at least a notch 21, a primary part 4 and a fixing box 31 located in one of the at least a notch 21.

### <Glazing Panel>

In one embodiment, the glazing panel can comprises at least one glass sheet 21.

In another embodiment, due to reduction of induced deformations on the glazing panel, the glazing panel can comprise a laminated glass panel, as illustrated in FIG. 7. The laminated glass panel 2 comprises glass sheets 21, 22 maintained by one or more interlayers 23 positioned between glass sheets. The interlayers 23 employed are typically polyvinyl butyral (PVB) or ethylene-vinyl acetate (EVA) for which the stiffness can be tuned. These interlayers 23 keep the glass sheets bonded together even when broken in such a way that they prevent the glass from breaking up into large sharp pieces.

The material of the glass sheet 21, 22 can independently be, for example, soda-lime silica glass, borosilicate glass, aluminosilicate glass or other materials such as thermoplastic polymers or polycarbonates which are especially known for automotive applications. References to glass throughout this application should not be regarded as limiting.

The glass sheet can independently be a clear glass or a coloured glass, tinted with a specific composition of the glass or by applying a decorative coating, paint or a plastic layer for example. The glass sheet can have any shape to fit to the opening such as a rectangular shape, in a plan view by using a known cutting method. As a method of cutting the glass sheet, for example, a method in which laser light is irradiated on the surface of the multi-glazed window to cut the glass sheet, or a method in which a cutter wheel is mechanically cutting can be used.

The glass sheet can independently be manufactured by a known manufacturing method such as a float method, a fusion method, a redraw method, a press molding method, or a pulling method. As a manufacturing method of the glass sheet, from the viewpoint of productivity and cost, it is preferable to use the float method.

In the case of a laminated glass panel, it could be advantageous to have varying thicknesses of glass sheets to reduce weight and noise. Due to of induced deformations on the glazing panel, thin glass sheets with a thickness less than 1 mm can be used without be bent or deformed. Thus, such thin glass sheet can keep the desired design.

The shape of the window unit in a plan view (in the X-Z plane) is usually a rectangle, especially for a window unit used as a vehicle roof. Depending of the application, the shape is not limited to a rectangle and may be a triangle, a trapeze, a circular-shape, a hex or the like. Corners are preferably rounded.

The glazing panel can be a flat or curved panel to fit with the design of the car. The glazing panel can be processed, ie annealed, tempered, . . . to respect with the specifications of security and anti-thief requirements. A heatable system, for example a coating or a network of wires, can be applied on the glazing panel to add a defrosting and/or a demisting function for example.

Specifically, in case of glazing panel used as a part of a roof, the light transmission is preferably below 30% preferably below 15%.

### <Notch>

According to the invention, a notch is an indentation on an edge of the glazing panel.

In a first embodiment illustrated in FIG. 1, the glazing panel comprising one notch 21 used for example to fix a beacon or alike on the front or the back of a glazing panel.

In a second embodiment illustrated in FIG. 2, the glazing panel comprising two notches positioned in the same lateral side. Such embodiment can be used if a vehicle roof comprised several vehicle glazing assembly to fix rack. Such embodiment can also be used to fix an external element 6 on one side of the glazing panel for example a beacon with two fixations, a specific longitudinal rack for skis, . . . .

In such embodiment, a vehicle roof can comprised several glazing panels to form a larger roof and/or to add functionalities to said vehicle roof for example, fixing rack, beacons, . . . openable window, lighting for example to create zones in said roof with same or different functionalities.

In a third embodiment illustrated in FIG. 3, the glazing panel comprising four notches 21, 22, 23 and 24; each separately located in one of the at least four notches. The first notch 21 and the second notch 22 are substantially disposed in axial symmetry 20 such as for the third notch 23 and the fourth notch 24; the axis being a longitudinal median axis of the glazing panel.

In some embodiments, another notch can be used for another purpose.

Such embodiment is preferably used to fix lateral rack or alike to fix an external element 6 such bike(s), skis, snowboard(s), roof box(es), or alike.

In such embodiment, longitudinal racks can also be fixed if desired.

According to the invention, the number of notches depends on the desired application(s) and the way to fix one or more external element(s).

In the first embodiment, one notch is enough to fix a beacon or alike while in the third embodiment four notches are present to fix to racks or alike.

It is understood that it is possible to combine different embodiments for example one notch for a beacon and several notches to fix a rack in a same vehicle glazing assembly.

According to the invention, dimensions of the notch depends on the application, the position on the edge of the glazing panel, the size of the fixing box and then the size of the fixation of the external element to fix through said fixing box.

In some embodiments, the length of the notch can be about 330 mm and the width of about 80 mm.

According to the invention, the at least one notch 21, 22, 23, 24 is designed to at least partially enclose a space41, 42, 43, 44 in which the corresponding fixing box 31, 32, 33, 34 will be placed as illustrated in figures.

### <Fixing Box>

According to the invention, as illustrated in FIG. 7, the fixing box 31 allows access to the vehicle body 5 on which the vehicle glazing assembly is mounted onto. The fixing box allows to access through the fixing box from the outside, the side of the exterior surface 25 of the glazing panel facing the outside of the vehicle, to the vehicle body.

The expression “through the fixing box” means that the fixing box 31 has a blank volume 310 allowing from the outside to penetrate the fixing box to reach the vehicle body 5.

The external element 6 has a fixing means 61 corresponding to a fixation means 51 of the vehicle body. Said fixings means 61 is designed to be fixed to the corresponding fixation means 51 of the vehicle body.

To fix an external element, a part of said external element passes through the fixing box and is fixed by the fixing means 61 into the fixation means 51.

According to the invention, the vehicle glazing assembly is preferably mounted onto the vehicle body by a glue and more preferably, to ensure the fixation, between the glue and the interior surface 26 of the glass, opposite to the exterior surface 25, there is a primer as between the vehicle body and the glue.

Coming back to FIG. 1, FIG. 2, FIG. 5 and FIG. 7, according to the invention, a fixing box 31, 32, 33, 34 is located in one of the at least a notch 21, 22, 23, 24.

In preferred embodiments, a single fixing box is partially enclosed by a single notch meaning that a fixing box can protrude from the notch as illustrated.

In some particular embodiments, a single notch can comprise several fixing boxes.

### <Primary Part>

As illustrated in FIG. 1, the primary part 4 is placed along at least a part of the edge comprising the at least one notch. Preferably, the primary part 4 has a frame profile and encompasses the edge of the glazing panel on at least one peripheral side.

Depending on the desired application the primary part can also be placed in other location of the edges of the glazing panel.

According to some embodiments, as illustrated in FIG. 2 and FIG. 5, the primary part can surround the glazing panel to protect edges while ensuring the tightness of the glazing panel. In such embodiments, the primary part 4 has a frame profile and encompasses edges of the glazing panel on peripheral sides.

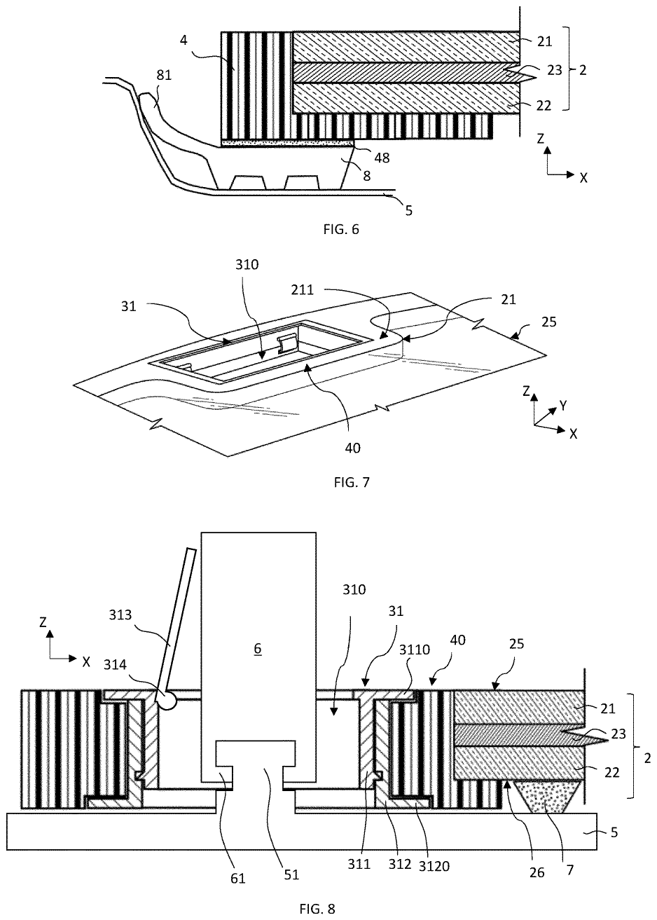

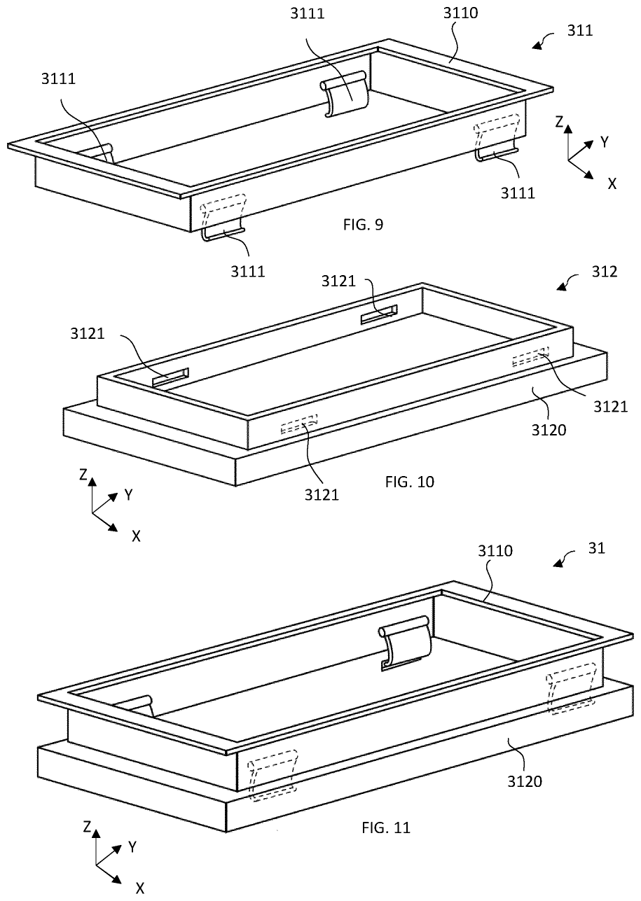

In some preferred embodiments according to the invention, as illustrated in FIG. 6, the primary part 4 encompasses totally the edge of the glazing panel. Preferably, to increase overall adhesion and also to allow a controlled spacing for the glue bead 7, the primary part is also attached to a part of the bottom surface of the glazing panel.

In some preferred embodiments, to increase the adhesion, a primer layer is disposed between the primary part and the glazing panel.

The primary part can be overmolded on the glazing panel. To facilitate the process, the primary part is preferably injected into a mould to be encapsulated on the glazing panel.

The primary part can have a specific shape to fulfil with the requirement of the desired application. In some embodiments, the primary part can have extensions 41 to ensure the mechanical strength of the window unit.

According to the invention, at least a portion of the primary part is disposed in a flush manner with the exterior surface to reduce the sound and vibrations created by the air flowing along the vehicle glazing assembly.

It is understood that objects placed in a flush manner means that that the top surface of each of the objects is substantially in the same plane. This arrangement is preferred for aesthetic and aerodynamic reasons.

As illustrated in FIG. 6, FIG. 7 and FIG. 8, the top surface 40 of the primary part is disposed in a flush manner with the exterior surface 25 of the glazing panel 2.

### <Sealing Component>

According to the invention, the primary part 4 is in the form of a sealing component.

It is understood that a sealing component is a component to seal the glass panel. Preferably the sealing component has a 50-90 ShA. More preferably, the sealing component has a shore A about 90.

Preferably, the sealing component is a polyurethane (PU) based material and more preferably the sealing component is an aromatic PU.

According to some embodiments, the sealing component can be TPE, TPV or EPDM depending on the desired application and process.

According to some embodiments, locally a primary material can be used to ensure the bonding with the sealing material.

In some embodiments of the invention, as illustrated in FIG. 6, the frame can comprise a secondary part 8 which is in the form of soft component, placed at least partially over the primary part 4. The secondary part allows to thigh the window unit on the structure where it is fixed. Such structure can be a vehicle body, a building, . . . .

The secondary part can be injected in a step, done after the step of injecting the primary part, over at least partially the primary part. Preferably, the secondary part is a single part. In some embodiments, the secondary part can be locally in contact with the glazing panel to ensure the aesthetic and the tightness of the window unit.

In another embodiment, at least a portion of the secondary part is in contact with the glazing panel and preferably at least in contact with the glazing panel at the level of the at least one constraints releasing mean.

The soft component has a natural chemical cohesive bonding with the hard component.

The soft component has a young modulus lower than 1000 MPa. The soft material, which has a young modulus lower than 1000 MPa can be made of thermoplastic elastomer based material. Styrenic based and vulcanized thermoplastics elastomer are generally used. The soft component is in another embodiment a soft polyvinyl chloride.

The soft component is used to give the final surface aspect of the frame and also to fit the window unit to the vehicle body. Effectively, the softness of the material allow interferences between the vehicle body and the window unit by the use of soft lips. Soft component is sometimes also used to insure a sealing function between the vehicle body and the encapsulated window unit.

In a preferred embodiment, the soft component is a thermoplastic elastomer (TPE) based material.

According to one embodiment of the present invention, the frame profile encompassing the edge of the glazing panel on at least one peripheral side and is made of soft component which has a natural chemical cohesive bonding with the sealing material. Thus, a good adhesion between the frame profile and the primary part may be obtained without using a primer between the two parts.

Coming back to FIG. 7 and FIG. 8, according to some embodiments of the invention, to promote the reduction of the vehicle's air penetration coefficient, the fixing box can be disposed in a flush manner with the primary part.

As illustrated in FIG. 8, the exterior surface 25 of the glazing panel, the primary part and the fixing box are disposed in a flush manner.

According to some embodiments, the fixing box can comprise a flap 313 to close the fixing box in a flush manner and to cover the blank volume 310 to prevent the air from being disturbed by this blank volume and to increase the fluidity of the air in the box when an external element is not fixed to the vehicle body. The fixing box can comprises an opening means 314, such a hinge or alike, to allow the flap to be opened and/or to be closed. The fixing box can also comprises a position means to maintain the flap in a desired position, such as open or close position. The fixing box can also comprises a stopper to block the flap in a desired close position while preventing the flap to enter into the blank volume.

In such embodiments, the flap is preferably designed to reduce the vehicle's air penetration coefficient even in an open mode, when an external element is fixed to the vehicle body. Thus, the flap needs to be opened before fixing the external element to a fixation means 51 of a vehicle body.

In some embodiments, the fixing box can be inserted in a mold and the primary part is injected around the box to connect the fixing box with the glazing unit.

In some other and preferred embodiments, the fixing box is post attached, meaning that the primary part is injected with the glazing panel leaving a space 41, 42, 43, 44 to fix a fixing box in another step; the fixing box is connected to the glazing panel by the primary part.

As illustrated in FIG. 4, each of the spaces 41, 42, 43, 44 corresponds to the space where the primary part 4 is framing a fixing box 31, 32, 33, 34 and to connect said fixing box to the glazing panel 2 into the corresponding notch 21, 22, 23, 24 in some embodiments wherein the at least one fixing box is post attached.

According to the invention, terms “connect/connecting” for that purpose means that the fixing box and the glazing panel are joined together.

According to some embodiments, especially for post attached embodiments, the fixing box can comprise a top element 311 and a bottom element 312; the top element and the bottom element are designed to clamp the primary part.

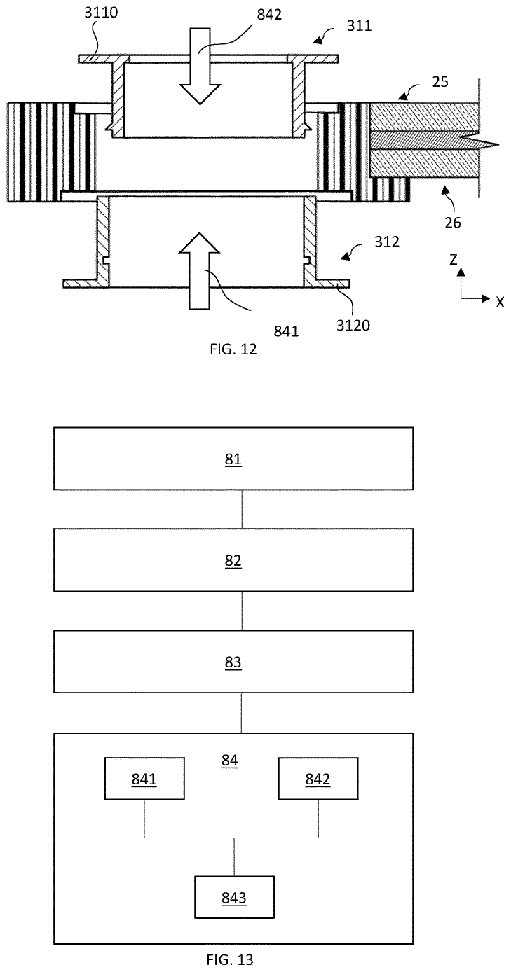

As illustrated in FIG. 8, FIG. 9, FIG. 11 and FIG. 12, the clamping can be performed by a specific edge shape 3110 on the top element 311 and a specific edge shape 3120 on the bottom element 312. In such embodiments, the primary part can be have a specific recess matching with the specific edge shape while having a flush design between the top element and the primary part.

In embodiments where a flap and a top element exist, the top element comprises the flap.

In some embodiments, the fixing boxes can be without a flap and in such embodiments is preferred to have a part of external element that is designed to fulfil the space of the fixing box to reduce problem of air flows.

Preferably, the top element and the bottom element can comprise clipping means 3111, 3121 to clip the top element and the bottom element together. Clipping means 3111 of the top element are designed to correspond to clipping means 3121 of the bottom element.

In some embodiments, clipping means 3111 of the top element can be a male clip (or several) while clipping means 3121 of the bottom element are corresponding to a female clip (or several) such as cutouts or holes.

According to some embodiments, the top element can be made of ABS based material, such as ABS124

According to some embodiments, the material of box can be made of an ABS based material, a POM based material.

According to some embodiments, the top element has the same composition than the bottom element.

According to some preferred embodiments, the top element is made of a ABS based material, such as ABS124+MM and the bottom element is made of a POM based material such as POM055.

According to the invention, dimensions of the box depends on the application and the external element to fix in. According to some embodiments in which the external element can be roof racks, the length of the box can be about 146 mm, the width of about 26 mm and a thickness of about 7 mm.

In preferred embodiments, the primary profile surrounds edges of the glazing panel as illustrated in FIG. 2 and FIG. 5 to protect the glazing panel while reducing vibration when the vehicle glazing assembly is attached to a vehicle body.

In preferred embodiments, the primary part is framing completely said fixing box meaning that said fixing box is fully surrounded by the primary part.

As illustrated in FIG. 13, to manufacture a vehicle glazing panel according to the fourth aspect of the invention, the method can comprise a step A of providing 81 the glazing panel. As explained above, the glazing panel can be manufactured by any known method that fulfil requirements such as tempering, lamination, bending or alike depending on the specific application.

According to the invention, the method can also comprise a step B of injection 82 the sealing component.

Preferably, the step B of injecting is preceded by a step of inserting the glazing panel into a mold.

The present invention also relates to a mold to produce a window unit according to the first aspect. The mold is designed to receive at least a part of the glazing unit on which the primary part will be inserted. It is understood that only the part of the glazing panel to be injected or the whole glazing panel can be inserted into the mold.

According to the invention, the mold comprises a cavity to create by an injection of the primary part.

In some embodiments, the mold can also comprise a specific design and/or parts to create at least a space 41, 42, 43, 44 to fix a fixing box in another step.

The mold comprises a top part and a bottom part. The parts can close up creating the cavity. The cavity is sealed once the parts are closed. The mold comprises at least one injection nozzle to inject into the cavity the primary part.

Preferably, the primary part is filling the notch around the corresponding fixing box or opening where a fixing box will be installed in a post attached step.

In some embodiments, the primary part can also protrude from the notch to well protect the fixing box.

According to the invention, the method can also comprise a step C of providing 83 the at least one fixing box. Said at least one fixing box can be manufactured by any known process in order to fulfil the requirements needed to manufacture a fixing box according to the present invention.

Following this step C, the method can comprises a step D of placing 84 each of the at least one fixing box 31, 32, 33, 34 in the corresponding space 41, 42, 43, 44 created in the primary part.

As illustrated in FIG. 13, according to some embodiments, the step D can comprise several substeps 841, 842, 843 to post-attach the at least one fixing box into the corresponding space created in the primary part partially surrounded by the corresponding notch.

In such embodiments, the step D can comprises a substep a of inserting 841 bottom element 312 from the bottom of the glazing panel into the opening, meaning from the interior surface 26 to inside of the space, as illustrated in FIG. 12.

Said step D can also comprise a substep b of inserting 842 the top element 311 from the top of the glazing panel into the space, meaning from the exterior surface 25 to inside of the space, as illustrated in FIG. 12.

It is understood that the substep 841 and the substep 842 can be made independently one before the other (841 before 842 or 842 before 841) or in the sustainably same time. Preferably, the top or the bottom element comprising the female part of the clipping means is inserted before the element comprising the male part of the clipping means to facilitate the fixation.

Thus, the step D can comprises a substep c of clipping 843 the top element and bottom element to clamp the primary part such illustrated in FIG. 8 and FIG. 11. It is understood that the top element and the bottom element are designed to be clipped together to clamp the primary part while to be maintained together. Preferably the top element and the bottom element are also designed to fit with the space created in the primary part such as the space is designed to fit with the corresponding fixing box.

The present invention also relates to a vehicle roof comprising a vehicle glazing assembly. The vehicle glazing assembly can be used a cielo windshield with a part of it used for the roof. The vehicle glazing assembly can also be used as a part of a vehicle roof. A vehicle roof can be composed of several vehicle glazing assemblies.

Preferably, the vehicle roof comprises a single and large vehicle glazing assembly to reduce the handling of manufacture while giving a larger area from the roof to handle inside a vehicle.

The present invention also relates to a vehicle comprising a vehicle body 5 and a vehicle roof as illustrated in FIG. 8. The vehicle body comprises at least one fixation means 51. Each of the at least one fixation means is designed to fix an external element 6, wherein each of the fixing boxes 31, 32, 33, 34, corresponds respectively to one of the at least one fixation means.

Thus, the present invention also relates to a method to assemble a vehicle glazing assembly onto a vehicle.

In some preferred embodiments, the vehicle can need a beacon or alike, thus, the vehicle glazing assembly comprises a notch and a fixing box to be able to fix such beacon.

In some other preferred embodiments, the vehicle body comprises four fixation means to fix to lateral bars. In such embodiments, the vehicle glazing assembly comprises a glazing panel comprising four notches. The vehicle glazing assembly comprises at least four fixing boxes, each separately located in one of the at least four notches and corresponding to a fixation means.

In such embodiments, preferably, the four fixing boxes 31, 32, 33, 34 are substantially disposed in axial symmetry two by two (31 with 32 and 33 with 34); the axis being a longitudinal median axis 20, corresponding substantially to the driving axis, of the glazing panel 2.

In preferred embodiments, to fix bars onto a vehicle, each of the flaps of the fixing box are opened, then a part of the bar is inserted into the fixing box to be fix to the fixation means of the vehicle body.

Once the external element is not inserted, flap are placed in a closed position.

It is understood that the vehicle can comprises as many as needed fixation means and the vehicle glazing assembly includes as many notches and fixing boxes as necessary for the said fixation means.

Indeed, the invention solves drawbacks of the prior art especially by allowing easy assembly, by reducing the tool costs, by giving the possibility to reduce the quantity of material used while keeping same and increased. The present invention also reduces the risk of breakage of vehicle glazing assembly mounted in a vehicle.

On top of that, the invention can be implemented for each fixation method to save addons (screws, tapes, clips, etc.).

In the present invention, the notches enable to maximize the usable glazing surface area compared to the conventional thru holes which cannot be allocated on the edge of the glazing like the notch of the present invention. Moreover, the notches of the present invention enable the fixing box which required to be connected to the vehicle body, not being in direct contact with the glazing, therefore reducing vibrations on the glazing and eliminating the risk of breakage of the glazing in contrast to the conventional thru hole solution in which the glazing has to be in direct contact with the fixing box or the other elements. The primary part framing the fixing box enhances the reduction of vibration, minimizing the transfer of vibration to the glazing. On top of maximizing the usable glazing surface area and the safety of the glazing, the present invention improves the aerodynamics of the vehicle thereby reducing the fuel consumption and CO2 emissions.

1. A vehicle glazing assembly designed to be fixed to a vehicle body, comprising:
a glazing panel, having an exterior surface, comprising a notch;
a fixing box located in the notch;
a primary part framing the fixing box and connecting the fixing box to the glazing panel, the primary part being in the form of a sealing component,
wherein the fixing box allows access to the vehicle body, and and wherein at least a portion of the primary part is disposed in a flush manner with the exterior surface.

2. A vehicle glazing assembly according to claim 1, wherein the fixing box is disposed in a flush manner with the primary part.

3. A vehicle glazing assembly according to claim 1, wherein the sealing component comprises a Polyurethane (PU) based material.

4. A vehicle glazing assembly according to claim 1, wherein the vehicle glazing assembly comprises a secondary part which is in the form of soft component, placed at least partially over the primary part.

5. A vehicle glazing assembly according to claim 1, wherein a primer layer is disposed between the primary part and the glazing panel.

6. A vehicle glazing assembly according to claim 1, wherein the glazing panel comprises a laminated glass panel.

7. A vehicle glazing assembly according to claim 1, wherein the fixing box comprises a flap to close the fixing box in a flush manner.

8. A vehicle glazing assembly according to claim 1, wherein the fixing box comprises a top element and a bottom element; the top element and the bottom element are being designed to clamp the primary part.

9. A vehicle glazing assembly according to claim 1, wherein the glazing panel comprises at least four notches, and wherein the vehicle glazing assembly comprises at least four fixing boxes, each separately located in one of the at least four notches.

10. A vehicle glazing assembly according to claim 9, wherein the at least four fixing boxes are substantially disposed in axial symmetry two by two; the axis being a longitudinal median axis of the glazing panel.

11. A vehicle roof comprising a vehicle glazing assembly according claim 1.

12. A vehicle comprising a vehicle body and the vehicle roof according to claim 11, wherein the vehicle body comprises at least one fixation means; each of the at least one fixation means being designed to fix an external element, wherein a fixing box, corresponds respectively to one of the at least one fixation means.

13. A method of manufacturing the vehicle glazing assembly according to claim 1, comprising
(A) providing the glazing panel;
(B) injecting the sealing component;
(C) providing the at least one fixing box; and
(D) placing the fixing box in a space created in the primary part.

14. The method of manufacturing the vehicle glazing assembly according to claim 13, wherein the placing the fixing box comprises:
(a) inserting a bottom element from a bottom of the glazing panel into an opening;
inserting a top element from the top of the glazing panel into an opening; and
clipping the top element and bottom element to clamp the primary part.

15. A mold configured to produce a vehicle glazing assembly according to claim 1, the mold being designed to receive at least a part of the glazing unit on which the primary part will be inserted, wherein the mold comprises a cavity to create by injection the primary part.

16. The vehicle glazing assembly according to claim 4, wherein soft component is a thermoplastic elastomer based material.
